(19) United States
(12) Patent Application Publication
(10) Pub. No.: US 2008/0273031 A1
(43) Pub. Date: Nov. 6, 2008

(54) Page based rendering in 3D graphics system

(75) Inventors: Pingping Shao, Cupertino, CA (US); Jiangbo Zhang, Mountain View, CA (US); Guofang Jiao, San Diego, CA (US); Jing Han, San Jose, CA (US); Tao Wang, Sunnyvale, CA (US); Ben (Hsueh-Ban) Lan, Cupertino, CA (US); Lingjun Chen, San Diego, CA (US)

Correspondence Address: DAVID AND RAYMOND PATENT FIRM, 108 N. YNEZ AVE., SUITE 128, MONTEREY PARK, CA, 91754, US

(73) Assignee: XGI Technology Inc. (Cayman)

(21) Appl. No.: 12/218,588

(22) Filed: Jul. 15, 2008

Related U.S. Application Data
(63) Continuation-in-part of application No. 11/299,142, filed on Dec. 8, 2005.

(51) Int. Cl. G06T 17/00

(52) U.S. Cl. 345/420

(57) ABSTRACT

A method of rendering 3D graphics image includes the steps of: storing the primitives information into the primitive bank and parameter bank whose entries are made up the primitive IDs; converting the primitives into the pages whose coordinates are made up the page IDs; matching incoming page IDs of the incoming primitive with the page IDs stored in the page RAM in such a manner that when the incoming page ID of the incoming primitive matches with the sorted page ID stored in the page RAM, the incoming primitive are added to the corresponding page node in the page RAM under the corresponding page ID; flushing the page RAM when the free page nodes of the page RAM less than a predetermined amount or when the primitive's counter of the page node reaches another predetermined number; and rendering the primitives stored in the page memory into pixels.

### CROSS REFERENCE OF RELATED APPLICATION

This is a Continuation-In-part application of a regular application having an application number of Ser. No. 11/299,142 and a filing date of Dec. 8, 2005.

### BACKGROUND OF THE PRESENT INVENTION

1. Field of Invention

The present invention relates to real time computer graphics, and more particularly to a rasterizer design in 3D graphics hardware architecture.

2. Description of Related Arts

FIG. 1 shows the graphics pipeline in a rendering system. The geometric processor 110 takes the vertex series and converts them to primitives that are sent to the primitive setup 112 in which the primitive data such as edge slopes, vertex coordinates and the parameter data such as color, depth, texture coordinates and their gradients are calculated. The rasterizer engine 114 takes the primitive data of a primitive and finds all pixels covered by the primitive. The interpolator engine 116 takes the pixels and the parameter data, calculates the color, depth, texture coordinates for each pixel. The depth of the pixels are sent to the depth engine 118 to determine its visibility; the texture coordinates of the pixels are sent to the texture engine 120 in which a texture colors of the pixel are calculated from a texture map stored in the frame buffer 136. A texture cache 130 is used to save the texture read memory bandwidths and to cover the memory read latency. The texture colors and color from the interpolator engine 116 are sent to the pixel engine 122 to calculate the final color of the pixel. The output engine 124 receives the color read and write requests from the pixel engine 122 and z read and write requests from the depth engine 118. The color cache 132 and the depth cache 134 are used to save the memory bandwidth. All the requests are arbitrated in the output engine 124 and then sent to the memory interface 126 to read or write from or to the frame buffer 136.

FIG. 21 is an example scene 2150 in which there are four primitives: the primitive 2151, the primitive 2152, the primitive 2153 and the primitive 2154. In the prior art, the primitive are rendered scanline by scanline in a primitive and primitive by primitive in a scene.

In computer graphics, the algorithms of primitive rasterizer can be broadly divided into two categories: namely immediate mode rendering algorithms and tile based rendering algorithms.

For the immediate mode rendering algorithm, as shown in FIG. 1 and FIG. 2 of the drawings, primitives are immediately converted into pixels in the same order as the primitives are transferred by a particular application. In this way, some of the pixels may be occluded by subsequent primitives but they would be nevertheless transferred into frame buffer which is a portion of a memory chip of the particular computing system in question. As a result, the process of identifying and drawing hidden pixels which have been occluded consumes considerable memory bandwidth in the memory chip and constitutes a bottleneck for most of the graphics accelerators. It is suggested that primitives sorting according to the distance to eye can avoid overdraw of pixels, but some popular features such as Alpha blending must rely on the order of primitives, which inevitably consumes considerable amount of memory bandwidths in the above-mentioned fashion.

On the other hand, for the tile based rendering algorithm, as shown in FIG. 3 and FIG. 4 of the drawings, a whole screen is subdivided into tiles, and the primitives are first binned into each tile to form a plurality of tile buffers, which in turn is to be written into local memory. After all of the primitives of a frame finish binning in each tile, the relevant tile buffers are read and retrieved wherein the primitives binned in the respective tile buffers are sorted in the order of distance-to-eye, and then converted into a corresponding arrangement of pixels.

It is suggested that because the size of this tile is much smaller than the whole screen, the memory bandwidth that stores color buffer and Z buffer can be integrated into graphics chip. After all of the primitives of a particular tile are rendered, the color buffer and the Z buffer are subsequently written into local frame buffer. This saves memory access bandwidth for the color and Z.

After all tiles of a particular frame (the whole screen) have completed the pixel rendering process, the final image is sent to display unit which then displays the image in question to a user. It is suggested, this method is adapted for rapid hidden pixel removal and therefore saves processing time and memory resources.

Though these advantages, tile based rendering algorithm also has disadvantages. First, the primitives of the whole frame (screen) have to be stored into many tile buffers and are read many times since they are shared by multiple tiles. The duplicative primitives need a relatively big buffer to store and consumes considerable amount of memory bandwidths. Second, the use of tile based rendering algorithms involves repeated setup computations for each primitive when the primitive covers multiple tiles. Last, the primitive size of a frame is limited by the architecture of the tile based rendering algorithms.

### SUMMARY OF THE PRESENT INVENTION

A main object of the present invention is to provide a method of rendering a 3D graphic image using page based rendering technique, wherein each of the primitives is first divided adaptively into a plurality of segments which are processed in the same way as that of the tile based rendering technique, while the primitives of the whole frame are rendered in the same way as the immediate mode rendering technique, such that the page based rendering technique substantially integrates the advantages of both the immediate mode rendering technique and the tile based rendering technique, while resolving the respective disadvantages in associated with the these graphics rendering techniques.

Another object of the present invention is to provide a method of rendering a 3D graphics image using page based rendering technique, wherein the primitives are processed on-chip in a page-by-page basis, so that there is no need to repeatedly sort and store the primitives for the whole frame. Another object of the present invention is to provide a method of rendering a 3D graphics image using page based rendering technique, wherein the primitives are assigned into tiles and pre-sorted in a tile basis before they are shaded and textured, so as to avoid tile switch between primitives, such that the memory read and write efficiency can be maximized. In other words, the present invention provides an efficient and effective method for rendering a 3D graphics image.

In order to accomplish the above objects, the present invention provides a method of rendering a 3D graphics image, comprising the steps of:

(a) storing the primitive data of the incoming primitive into a on-chip memory and parameter data into another on-chip memory, the entries of the two memories form the ID of the primitive; (b) finding all the pages toughed by the primitive, the top-left coordinates of a page form the ID of the page;

(c) matching incoming page IDs of the incoming primitive with the page IDs stored in the page RAM, in such a manner that when the incoming page ID of the incoming primitive matches with the sorted page ID stored in the page RAM, the incoming primitive is stored at the corresponding page node under in the page RAM the corresponding page ID, wherein when the incoming page ID of the incoming primitive does not match with the sorted page ID, a new page node is created under the corresponding incoming page ID of the incoming primitive which is stored at the new page node; and

(d) flushing the page RAM when the free page nodes of the page RAM less than a predetermined amount or when the primitive's counter of one of page nodes reaches another predetermined number;

(e) rendering the primitives stored in the page into pixels of the page; and

(f) repeating steps a, b, c, d, e until all primitives of a frame are processed.

These and other objectives, features, and advantages of the present invention will become apparent from the following detailed description, the accompanying drawings, and the appended claims.

### BRIEF DESCRIPTION OF THE DRAWINGS

FIG. 1 is a conventional method of an immediate mode rendering system for rendering a 3D graphics image.

FIG. 2 is a schematic diagram illustrating an operation of the immediate mode rendering technique for rendering a 3D graphics image.

FIG. 3 is a conventional method of a tile based rendering system for rendering a 3D graphics image.

FIG. 4 is a schematic diagram illustrating an operation of the tile based rendering technique for rendering a 3D graphics image.

FIG. 5 is a flow diagram of a method of rendering a 3D graphics image using page based rendering technique according to a preferred embodiment of the present invention.

FIG. 6 is a schematic diagram of a method of rendering a 3D graphics image using page based rendering technique according to the above preferred embodiment of the present invention.

FIG. 7A is a schematic diagram of a method of rendering a 3D graphics image using page based rendering technique according to the above preferred embodiment of the present invention, illustrating the manner of which the 3D graphics image is rendered.

FIG. 7B is a schematic diagram of page matching according to the above preferred embodiment of the present invention.

FIG. 8A is a flow diagram of banks' writing according to the above preferred embodiment of the present invention.

FIG. 8B is a flow diagram of the primitive bank reading according to the above preferred embodiment of the present invention.

FIG. 8C is a flow diagram of the parameter bank reading according to the above preferred embodiment of the present invention.

FIG. 9 is a flow diagram of page matching according to the above preferred embodiment of the present invention.

FIG. 10 is an alternative mode of the method of rendering 3D graphics image using paged based rendering technique according to the above preferred embodiment of the present invention.

FIG. 11 is a schematic diagram of the method of rendering 3D graphics image using paged based rendering technique according to the above the first alternative mode, illustrating that how the tiles are sorted.

FIG. 12 is a schematic diagram of the method of rendering 3D graphics image using paged based rendering technique according to the above the first alternative mode, illustrating that how the tiles are flushed.

FIG. 13 is a schematic diagram of the method of rendering 3D graphics image using paged based rendering technique according to the above the first alternative mode, illustrating that the tiles sorting is completed.

FIG. 14 is a diagram illustrating a disposition of the Page RAM according to the above preferred embodiment of the present invention.

FIG. 15 illustrates the disposition of primitive bank.

FIG. 16 illustrates the disposition of the parameter bank.

FIG. 17 illustrates how tile sorting works in the example 2150.

FIG. 18 illustrates the disposition of the tile RAM.

FIG. 19 is block diagram of tile sorting.

FIG. 20 is a schematic diagram of a method based on Primitive Bank and Parameter Bank.

FIG. 21 is a schematic diagram illustrating interrelation between pages, tiles and, pixels according to the above preferred embodiment of the present invention.

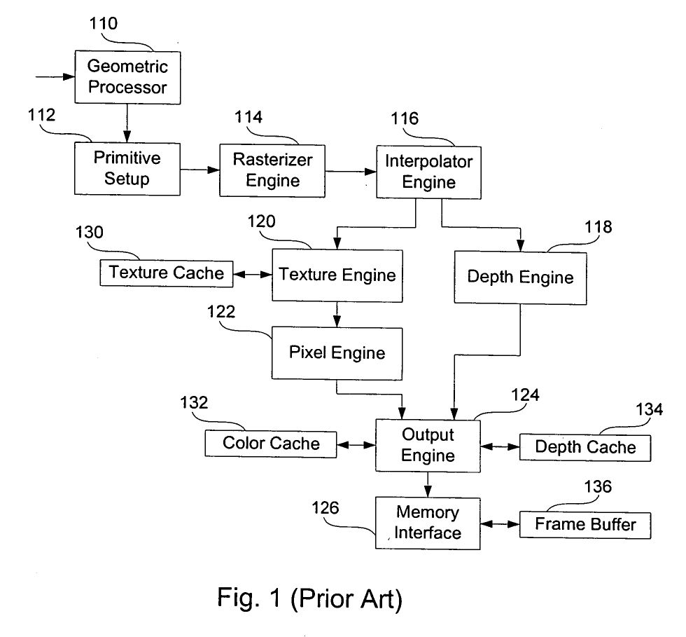

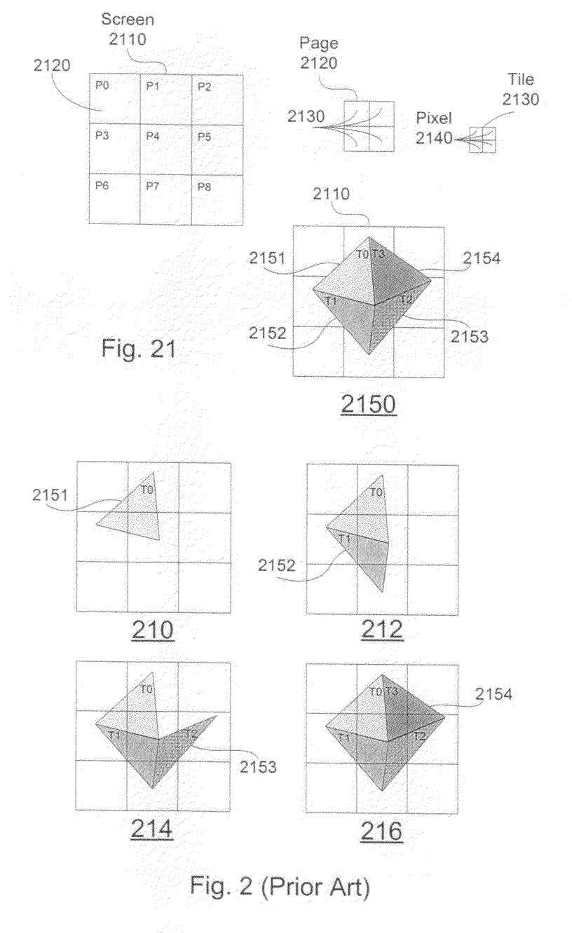

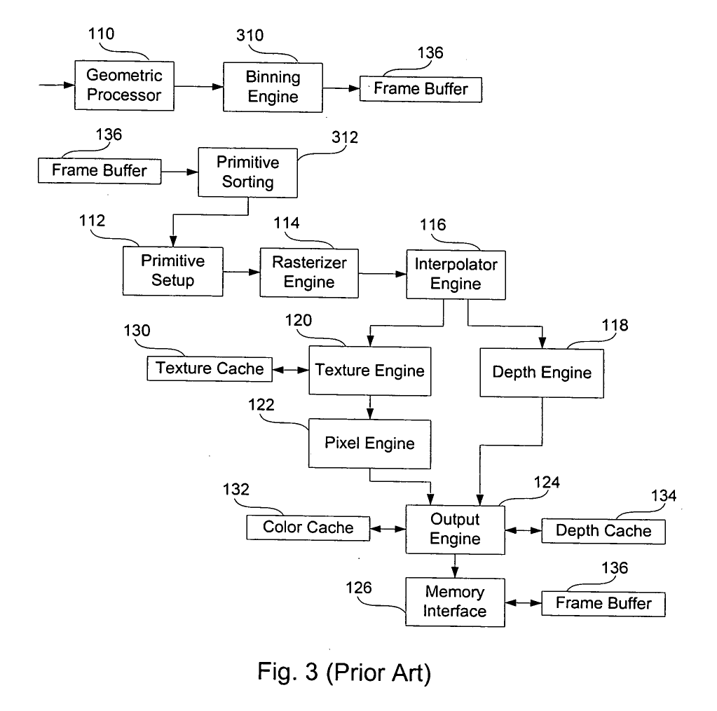

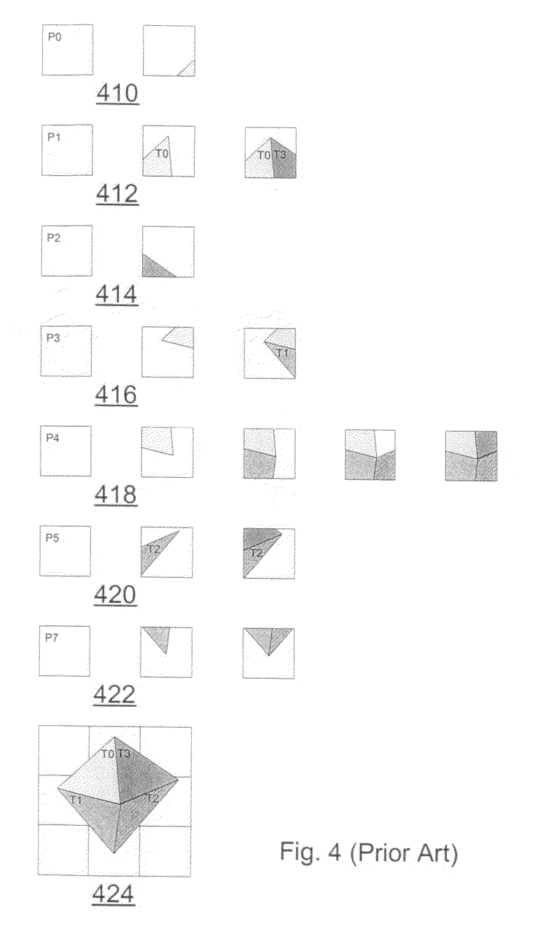

### DETAILED DESCRIPTION OF THE PREFERRED EMBODIMENT

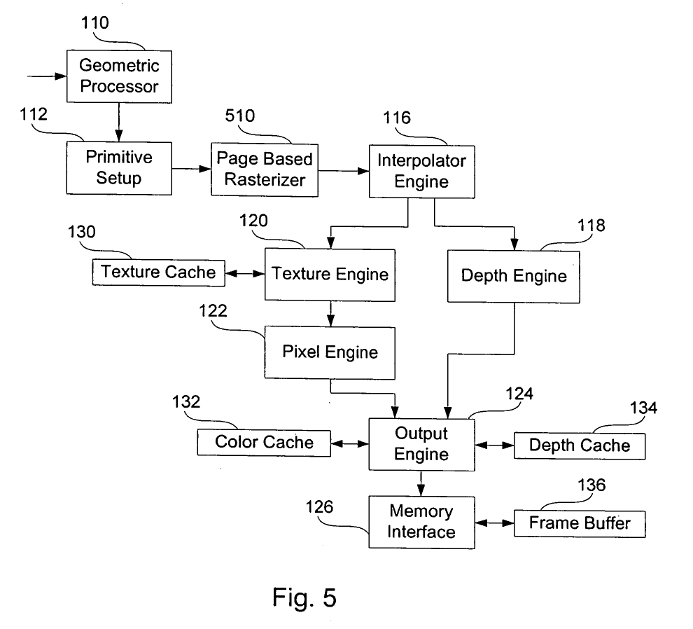

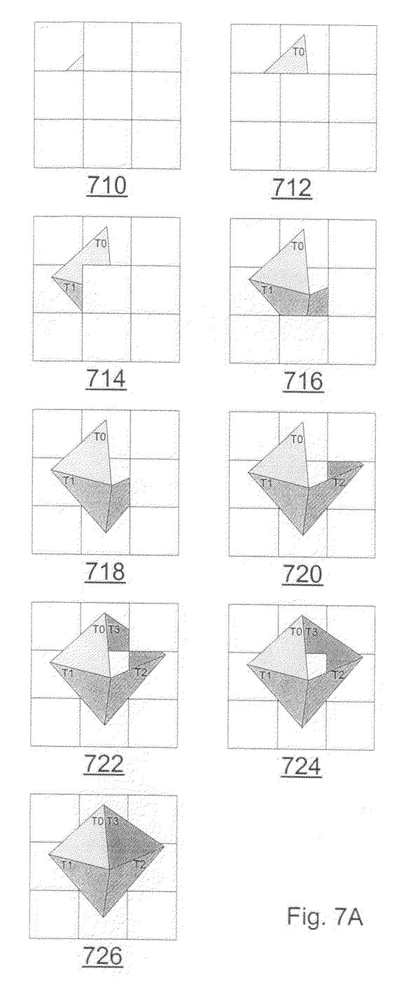

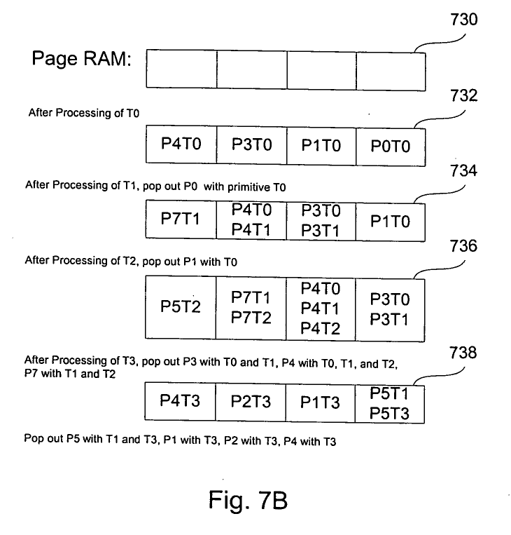

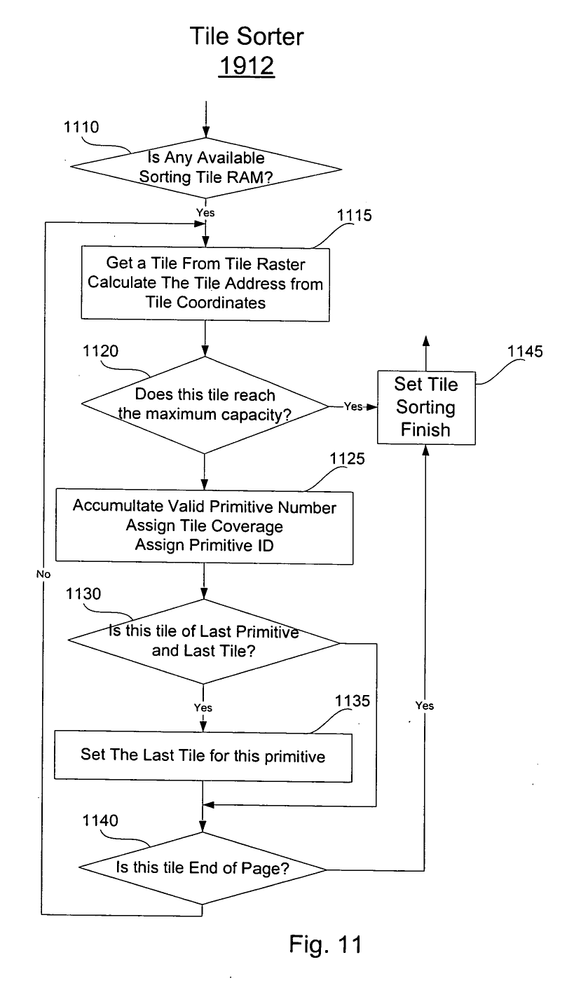

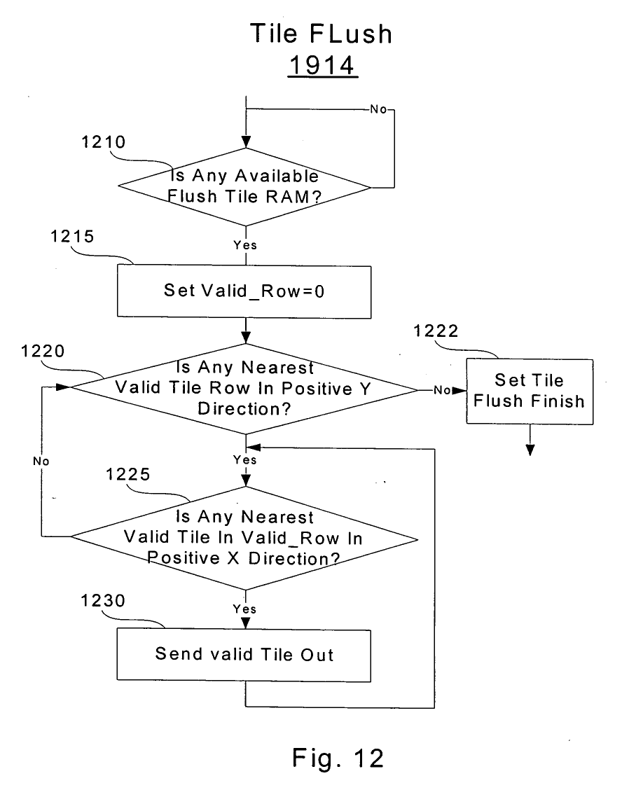

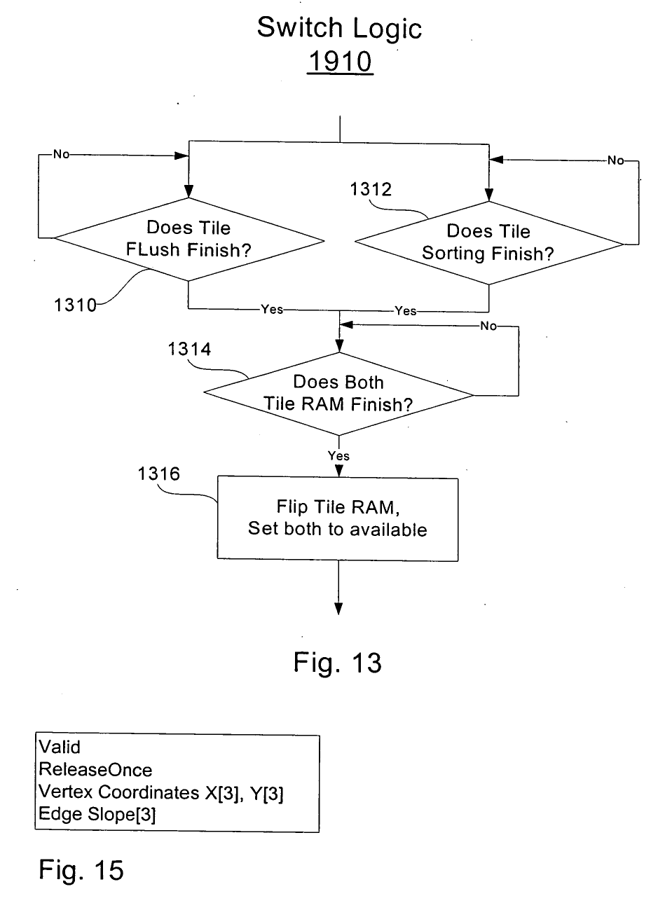

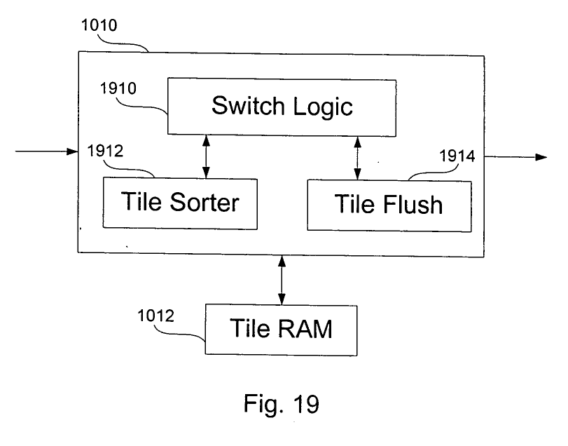

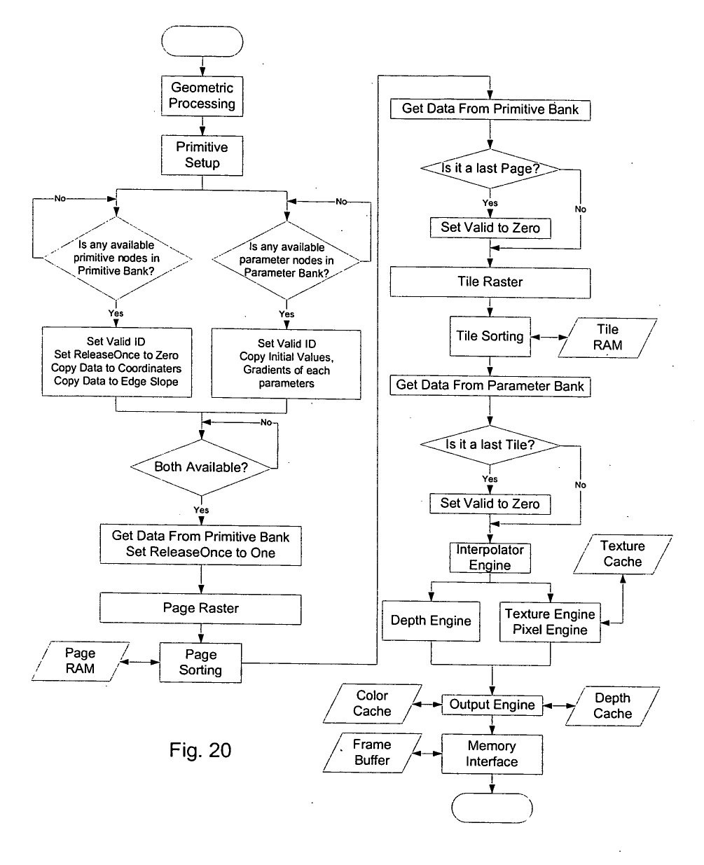

Referring to FIG. 5 to FIG. 21 of the drawings, a method of rendering 3D graphics image using page based rendering technique according to a preferred embodiment of the present invention is illustrated.

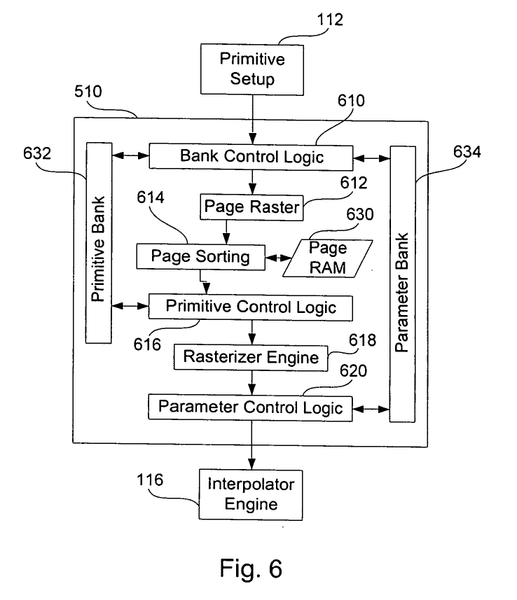

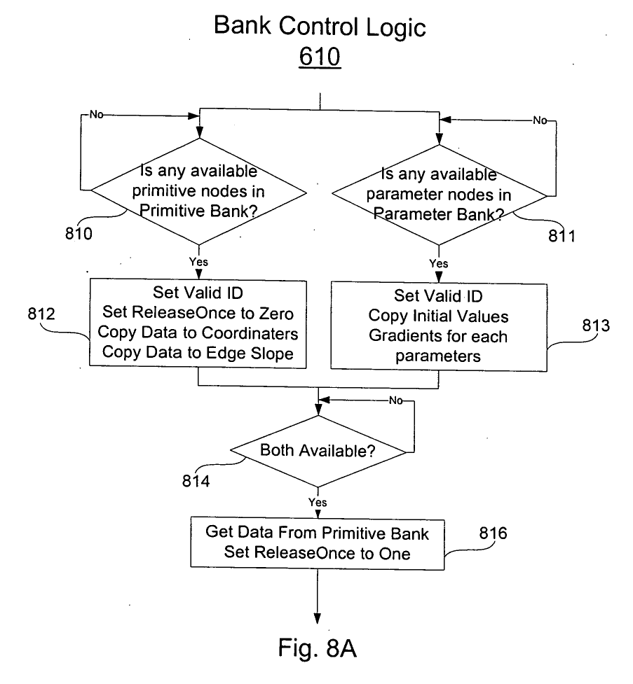

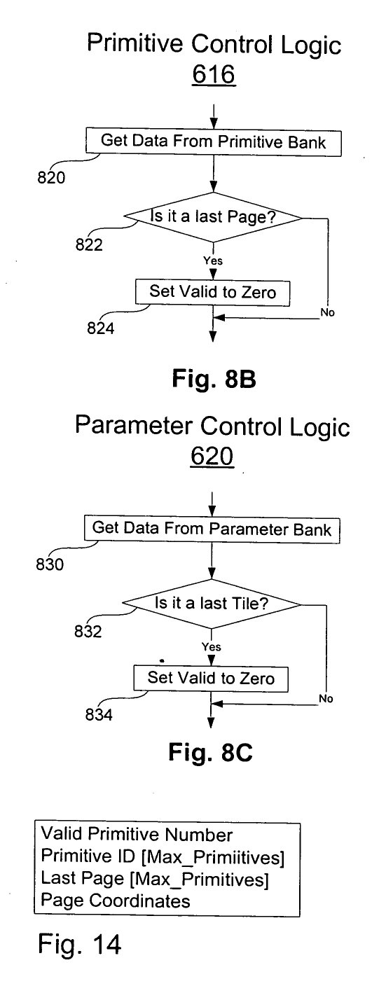

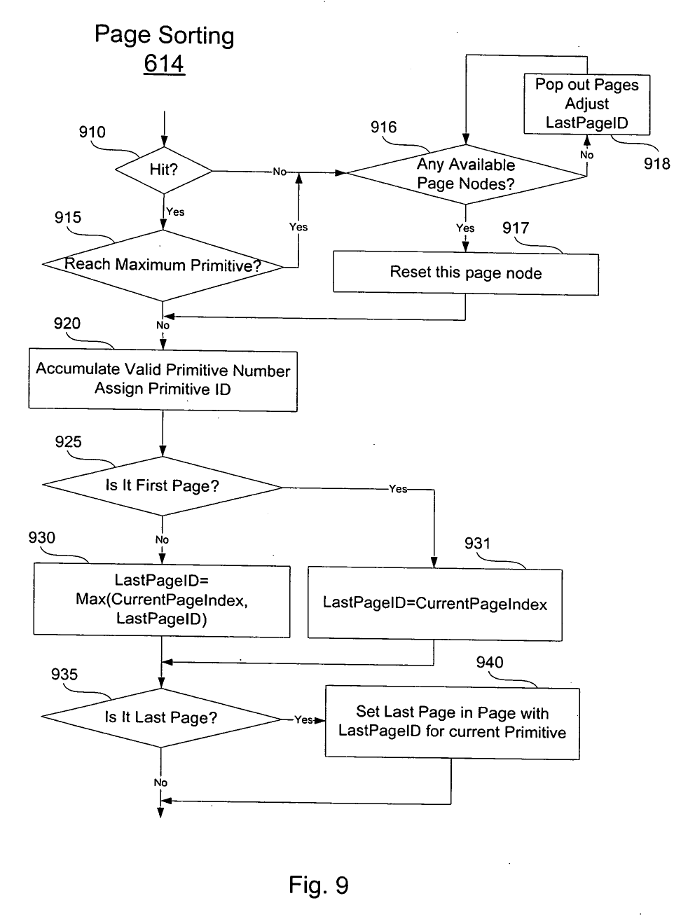

Referring to FIG. 6, FIG. 8, and FIG. 9 of the drawings, the method, which is according to a preferred embodiment of the present invention, comprises the steps of:

(a) storing the primitive data of the incoming primitive into the primitive bank 632 and parameter data into the parameter bank 634, the entries of the two banks form the ID of the primitive;

(b) finding all the pages toughed by the primitive, the top-left coordinates of a page form the ID of the page;

(c) matching incoming page IDs of the incoming primitive with the page IDs stored in the page RAM in such a manner that, when the incoming page ID of the incoming primitive matches with the sorted page ID stored in the page RAM, the incoming primitive is stored at the corresponding page node in the page RAM under the corresponding page ID, wherein when the incoming page ID of the incoming primitive does not match with the sorted page ID, a new page node is created under the corresponding incoming page ID of the incoming primitive which is stored at the new page node; and

(d) flushing the page RAM when the free page nodes of the page RAM less than a predetermined amount or when the primitive's counter of one of page nodes reaches another predetermined number; and

(e) rendering the primitives stored in the page into pixels of the page; and

(f) repeating steps a, b, c, d, e until all primitives of a frame are processed.

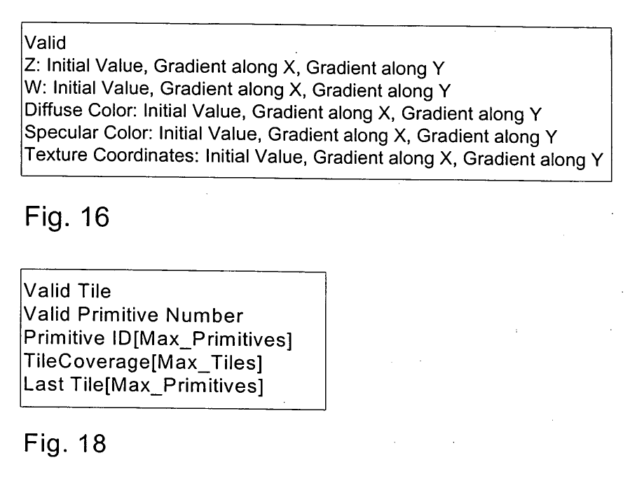

In the step (a), the operations of two banks are performed by a bank processing device comprising a primitive bank, a parameter bank and their control logics. The primitives are setup and the primitive data in FIG. 15 are stored in the primitive bank 632 and the parameter data in FIG. 16 are stored into the parameter bank 634 by the bank control logic 610. At the meanwhile, each of the primitives is designated by a primitive identification (ID) that is the entries of the both banks. The primitive control logic 616 reads the primitive data from the primitive bank 632 and releases the slot when last page of a primitive is read. The parameter control logic 620 reads the parameter data from the parameter bank 634 and releases the slot when last tile of a primitive is read.

In the following steps, the sorting the primitives for each of the pages is performed by a page processing device comprising a page raster, a page sorting and a page RAM.

In the step (b), The primitive having a primitive ID are checked in methods of the prior art to find the pages that have pixels in the primitive. Each of the pages is designated by a page identification (ID) that is the top-left coordinates of the page.

In the step (c), the sorting the primitives for each of the pages is performed by a page sorting 614 and a page RAM 630. The sorting of the primitives ID and the pages ID are transferred to the page RAM 630 which is a one-chip memory, and stored as a predetermined page node. Page sorting engine 614 checks incoming primitives' ID with the ones stored in the page RAM 630. Where the incoming primitive's page ID matches with the relevant stored page IDs, the incoming primitive would be added to an existing node of the page RAM 630 under the same ID. Where the incoming primitive's page ID does not match with any page ID stored in the page RAM 630, a new page node would be created for storing that new primitive's page ID under the corresponding primitive ID.

In the step (d), when the memory resources of the page RAM 630 less than a predetermined amount, or when the primitive's counter of one of page nodes reaches a predetermined number, the page nodes, having the corresponding page IDs and the primitives stored under those page IDs, are sent to a next engine in the order they are created.

In the step (e), the rasterizer engine 618 that is attached to the page sorting 614 in the embodiment, receives page IDs and the primitive list from the page nodes and renders all the primitives of the page nodes into pixels in the way of the prior art.

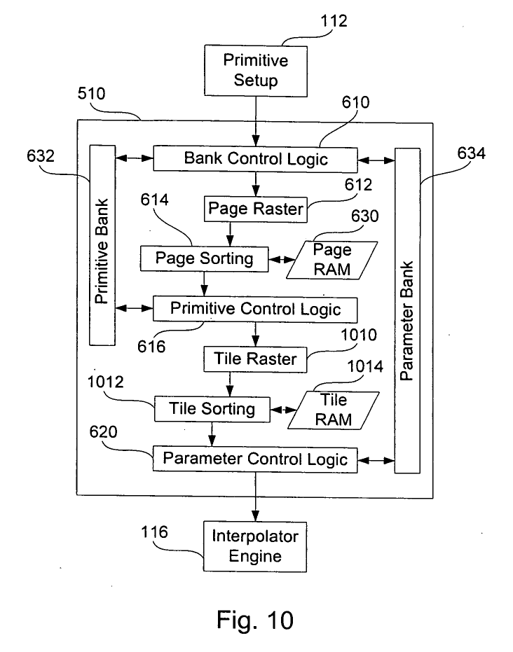

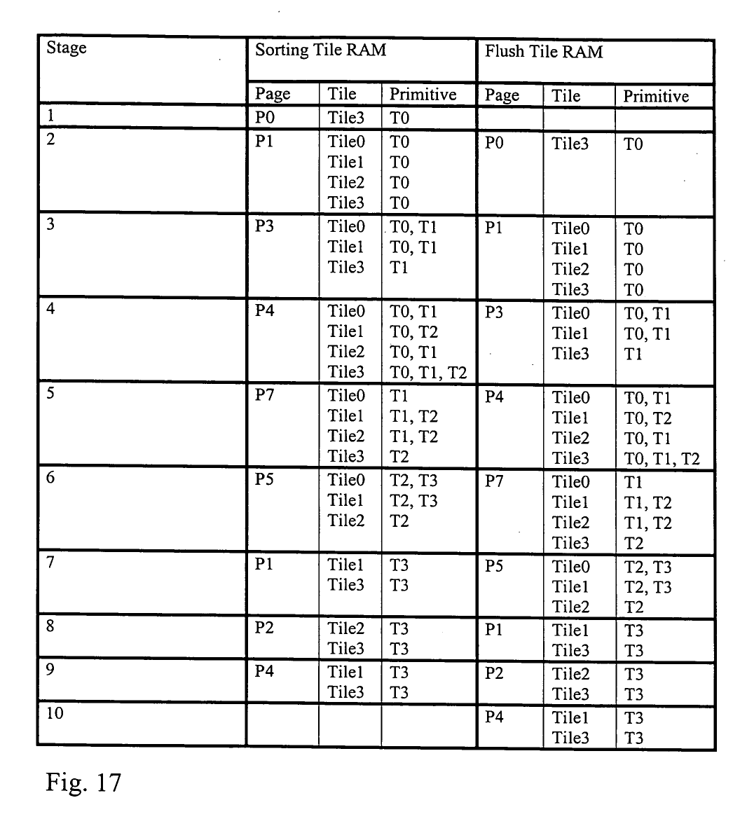

Referring to FIG. 10 to FIG. 13 of the drawings, and by reference to FIG. 14 to FIG. 21 of the drawings, an alternative mode of the method of rendering a 3D graphics image using page based rendering technique according to the preferred embodiment of the present invention is illustrated. The primitives are further performed by a tile processing device comprising a tile raster, a tile sorting and a tile RAM. The primitives in a page are converted into tiles of the page in the tile raster 1010 which calculates the TileCoverage and TileLast as well in the way of the prior art. The tile information shown in FIG. 17 are sorted by the tile sorting 1012 and stored in the tile RAM 1014. After all the tiles of the last primitive of the page are done, the tile sorting 1012 flushed all tiles in tile RAM 1014 in the spatial order into the interpolator engine 116. The alternative mode is similar to the preferred embodiment except that the method further comprises the steps, in the step (e), of:

(e.1′) converting the primitives of the incoming page by the tile raster 1010 into tiles;

(e.2′) sorting the tiles in the tile sorting 1012 and storing the sorted tiles in a tile RAM 1014;

(e.3′) verifying the number of primitives for each of the tiles, in such a manner that when the number of primitives exceeds a predetermined number, this single tile is flushed into the interpolator engine 116, or when the last tile of the current page is met, all the tiles of current page are flushed into the interpolator engine 116 in a spatial order.

Note that the number of primitives for each of the tiles should be a matter of customarily discretion, yet according to the preferred embodiment of the present invention, 16 in a tile is utilized.

Moreover, the tile RAM 1014 has nodes for all tiles on a page, each slot store up to 4 pairs of the coverage masks containing the respective primitive IDs. Tile Sorting 1012 updates the number of the primitives to take into account the incoming data. If the maximum primitive's count of the tile reaches 4, this single tile is flushed in to the interpolator engine 116. And when last tile of the current page is done, the tiles of whole page are sent into the interpolator engine 116 in the spatial order.

From the forgoing descriptions, it can be shown that the present invention also provides a page based 3D graphics rendering system for a displaying screen which is divided into a plurality of tiles, comprising a bank processing device, a page processing device, and a tile processing device.

The bank processing device comprises two banks and their control logics. Referring to FIG. 6 of drawing, the primitive bank 632 stores primitive data of primitives and the parameter bank 634 stores parameter data of primitives. The entries form the primitive IDs. Referring to FIG. 8A, the bank control logic 610 controls the write operation of two banks and creates the primitive IDs. Referring to FIG. 8B, the primitive control logic 616 controls read operation of the primitive bank 632 and release the entry when last page is processed. Referring to FIG. 8C, the parameter control logic 620 controls read operation of the parameter bank 634 and release the entry when last tile is processed. The page processing device is electrically connected with the bank processing device and adapted to sort the pages of the primitives with respective to the pages IDs.

The tile processing device is electrically communicated with the page processing device for rendering the primitives sorted in the page processing device into pixels which are displayed on the display screen in the tiles to form a 3D graphic image.

According to the preferred embodiment, referring to FIG. 6 of the drawings, the page processing device comprises a page raster 612, a page sorting 614 and a page RAM 630 electrically communicated with the bank processing device wherein the sorting of the primitives for each of the pages is performed by the page sorting 614. The sorted primitives ID and the pages ID are transferred to the page RAM 630 which is preferably a one-chip memory, and stored as a predetermined page node. Page sorting 614 checks incoming primitives' ID with the ones stored in the page RAM 630. Where the incoming primitive's page ID matches with the relevant stored page IDs, the incoming primitive would be stored to an existing node of the page RAM 630 under the same ID. Where the incoming primitive's page ID does not match with any page ID stored in the page RAM 630, a new page node would be created for storing that new primitive's page ID under the corresponding primitive ID.

The tile processing device comprises a tile raster 1010, a tile sorting 1012 and a tile RAM 1014. It adapted to render all primitives of the page nodes. Specifically, when the memory resources of the page RAM 630 less than a predetermined amount, the page nodes, having the corresponding page IDs and the primitives stored under those page IDs, are sent to a tile raster 1010. The tile raster 1010 receives page IDs and the primitive list from the page nodes, and renders all primitives of the page nodes into tiles.

The tile sorting 1012 receives tile information as shown in FIG. 17, and sorts it into Tile RAM 1014 according to the tile position and flushes the tile into next engine. Tile RAM 1014 is composed of Flush Tile RAM and Sorting Tile RAM. They have same size that is sum of all tiles in a page, and could be switched to each other. When a tile ram is currently used to store tile information from Tile Sorting 1012, it acts as Sorting Tile RAM. When a tile ram is used to send data to Interpolator, it acts as Flush Tile RAM. The tile switch 1014 controls when to switch Sorting Tile RAM and Flush Tile RAM each other.

As shown in FIG. 5 to FIG. 21 of the drawings, from the forgoing descriptions, it can be seen that the objects of the present invention have been accomplished. The present invention provides a method and a system for rendering 3D graphics image using page based rendering technique, which substantially resolves the shortcomings of the conventional 3D graphics image rendering techniques.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of rendering a 3D graphics image on a display screen, comprising the steps of:
(a) storing said primitive data of said incoming primitive into said primitive bank and said parameter data into said parameter bank, the entries of the two banks form the ID of said primitive;
(b) finding all the pages toughed by the said primitive, the top-left coordinates of a page form the ID of said page;
(c) matching incoming page IDs of said incoming primitive IDs with said page IDs stored in said page RAM in such a manner that when said incoming page ID of said incoming primitive matches with said sorted page ID stored in said page RAM, said incoming primitive is stored at said corresponding page node in said page RAM under said corresponding page ID, wherein when said incoming page ID of said incoming primitive does not match with said sorted page ID, a new page node is created under said corresponding incoming page ID of said incoming primitive which is stored at said new page node; and
(d) flushing said page RAM when there is no more free page node or when said primitive's counter of one of page nodes reaches said predetermined number;
(e) rendering said primitives stored in said page into pixels of said page; and
(f) repeating steps a, b, c, d, e until all said primitives of a frame are processed.

2. The method, as recited in claim 1, wherein said step (e) comprises the steps of:
(e.1′) converting said primitives in said page into a plurality of tiles;
(e.2′) sorting said tiles and storing said sorted tiles in a tile RAM; and
(e.3′) verifying a number of primitives for each of said tiles in such a manner that when said number of primitives exceeds a predetermined number, said corresponding tile is flushed into the next engine, or when said last tile of said page is met, all said tiles of said page are flushed into next engine in a spatial order.

3. The method, as recited in claim 2, wherein said tile RAM is adapted to store at most four pairs of said coverage masks containing said respective primitive IDs.

4. A paged based 3D graphics rendering system for a display screen divided into a plurality of tiles, comprising:
a bank processing device which stores a plurality of primitives having respective primitive IDs, wherein said primitives are divided into a plurality of pages having respective page IDs;
a page processing device electrically connected with said bank processing device and adapted to sort said pages of said primitives with respective to said pages IDs; and
a tile processing device electrically communicated with said page processing device for rendering said primitives sorted in said page processing device into pixels which are displayed on said display screen in said tiles to form a 3D graphic image.

5. The page based 3D graphics rendering system, as recited in claim 4, wherein said bank processing device comprises a primitive bank and a parameter bank and their control logics wherein said primitive bank stores said primitive data of said primitives, said parameter bank stores said parameter data of said primitives and said control logics forms said primitive IDs from the entries of said banks and controls the read, write and release operations of said banks.

6. The page based 3D graphics rendering system, as recited in claim 4, wherein said page processing device comprises a page raster, a page sorting and a page RAM electrically communicated with said bank processing device wherein a sorting of said primitives for each of said pages is performed by said page sorting and said sorted primitives ID and the pages ID are transferred to said page RAM and stored as a predetermined page node in such a manner that when an incoming primitives an incoming primitive's page ID matches with said one of said stored page IDs, said incoming primitive is stored to said page node of said page RAM under said page ID, wherein when said incoming primitive's page ID does not match with said page ID stored in said page RAM, a new page node is created for storing said incoming primitive's page ID.

7. The page based 3D graphics rendering system, as recited in claim 4, wherein said tile processing device comprises a tile raster, tile sorting and a tile RAM which adapted to render said primitives of said page nodes in such a manner that said tile raster is adapted to convert said primitives into said tiles of said display screen and said tile sorting is adapted to sort said tiles into said tile RAM and to flush said tiles in said tile RAM into an interpolator engine for rendering said 3D graphics image.
